(19) United States
(12) Patent Application Publication
(10) Pub. No.: US 2021/0406404 A1
(43) Pub. Date: Dec. 30, 2021

(54) METHODS AND APPARATUS FOR PERFORMING A CRYPTOGRAPHIC OPERATION WITH A KEY STORED IN A HARDWARE SECURITY MODULE

(71) Applicant: Arm Cloud Technology, Inc, San Jose, CA (US)

(72) Inventor: Brendan James MORAN, Histon (GB)

(21) Appl. No.: 16/914,774

(22) Filed: Jun. 29, 2020

(51) Int. Cl. G06F 21/71; H04L 9/08; H04L 9/32; G06F 21/60; H04L 9/30

(52) U.S. Cl. CPC G06F 21/71; H04L 9/0897; H04L 9/3236; G06F 2221/2149; H04L 9/30; G06F 2221/2103; G06F 21/606

(57) ABSTRACT

Aspects of the present disclosure relate to an apparatus comprising secure enclave circuitry, and processing circuitry to execute computer program instructions. The computer program instructions correspond to an operation comprising accessing a cryptographic key, the key being stored in a hardware security module. Executing the computer program instructions comprises transmitting, to the secure enclave circuitry, computer program instructions corresponding to said operation. The secure enclave circuitry is configured to initiate communication with the hardware security module, perform, with the hardware security module, an attestation process in respect of said operation, and execute said operation.

### BACKGROUND

The present technique relates to the field of cryptographic operations conducted via the use of a cryptographic key. Security can be compromised if cryptographic keys can be obtained by an unauthorised party such as a malicious attacker. Various methods have therefore been developed for protecting cryptographic keys.

One solution for protecting cryptographic keys is to store the keys in a hardware security module (HSM). HSMs can store cryptographic keys in a secure manner, offering assurances as to their extractability. However, unless access to the HSM is secured to prevent unauthorised use, an unauthorised user could simply use the HSM instead of having to steal the key.

In some systems in which a human user is to authenticate access to a HSM, security may be provided by requiring the user to authenticate themselves by way of a password, personal identification number (PIN), biometric data, or the like. However, this access model presents problems when applied to software, as opposed to a human user, which is to access a HSM. If such software is to authenticate itself via credentials, those credentials must be stored in such a manner that they are accessible to the software. This can lead to insecure practices such as storing a HSM in a plain text configuration file so that the software can access it. In general, PINs and passwords provide poor security for software, because they can be directly extracted from the software.

There is therefore a desire for a way for software to securely authenticate itself to a HSM, to allow cryptographic operations to be performed.

### SUMMARY

At least some examples provide a apparatus comprising:

secure enclave circuitry;

processing circuitry to execute computer program instructions, wherein:
the computer program instructions correspond to an operation comprising accessing a cryptographic key stored in a hardware security module; and
wherein executing the computer program instructions comprises transmitting, to the secure enclave circuitry, computer program instructions corresponding to said operation,

the secure enclave circuitry being configured to:
initiate communication with the hardware security module;
perform, with the hardware security module, an attestation process in respect of said operation;
   execute said operation.

Further aspects provide an apparatus comprising:

interface circuitry to communicate with secure enclave circuitry of a processing device; and

hardware security module circuitry to:
receive, from the secure enclave circuitry and via the interface circuitry, a request to open a communication channel;
perform, with the secure enclave circuitry, an attestation process in respect of an operation, said operation comprising accessing a stored cryptographic key; and
responsive to a successful outcome of the attestation process, perform said operation.

Further aspects provide a method comprising:

initiating communication between a hardware security module and a secure enclave of a processing device;

performing, by the secure enclave and the hardware security module, an attestation process in respect of an operation to be performed by the secure enclave, said operation comprising accessing a cryptographic key stored in the hardware security module; and

responsive to a successful outcome of the attestation process, performing said operation by the secure enclave, wherein the hardware security module facilitates performance of said operation.

Further aspects, features and advantages of the present technique will be apparent from the following description of examples, which is to be read in conjunction with the accompanying drawings.

### BRIEF DESCRIPTION OF THE DRAWINGS

FIG. 1 schematically depicts a system according to a comparative example.

FIG. 2 schematically illustrates a system according to an example of the present disclosure.

FIG. 3 illustrates a method according to an example.

FIG. 4 illustrates a method according to an example.

FIG. 5 illustrates a method according to an example.

### DESCRIPTION OF EXAMPLES

As noted above, it is desirable to provide a secure way for software to authenticate itself to a HSM. Some comparative systems may attempt to provide this by storing HSM access credentials within a secure storage or a secure element of a processing system. However, this essentially just moves the problem somewhere else: software that is to access the secure element would do so by providing credentials, and storing those credentials presents the same problem as storing the HSM credentials.

In an aspect of the present disclosure, an apparatus is provided comprising secure enclave circuitry and processing circuitry. The processing circuitry may be general processing circuitry, for example a core of a central processing unit (CPU). The secure enclave circuitry allows a portion of code to be protected against outside access and potentially encrypted at rest, thereby allowing a higher degree of security (for example for credentials and keys). For example, the secure enclave circuitry may be configured to block external transmission, to entities other than the HSM, of secure data associated with the operation that is described below.

The processing circuitry is configured to execute computer program instructions corresponding to an operation comprising accessing a cryptographic key, the cryptographic key being stored in a HSM. Executing the computer program instructions comprises transmitting, to the secure enclave circuitry, computer program instructions corresponding to said operation. The processing circuitry can thus configure the secure enclave circuitry to perform the cryptographic operation.

The secure enclave circuitry is configured to initiate communication with the HSM and to perform, with the HSM, an attestation process in respect of the operation. The attestation process (an example of which is described below) allows the software (i.e. the computer program instructions) to be securely identified to the HSM, so that from the perspective of the HSM there is confidence that the software is allowed to access the cryptographic key. For example, the attestation process may be based on said computer instructions, allowing the instructions to be specifically identified and confirmed as authorised. The secure enclave circuitry is configured to then execute the operation. The secure enclave circuitry may be configured to, following execution of the operation, transmit to the processing circuitry an output of said operation. The operation can thus be securely performed, with the integrity and security of the cryptographic key being protected, in such a way that the processing circuitry obtains the output of the operation and can proceed to use this output in further processing.

As a consequence of the use of the secure enclave circuitry in combination with the attestation process, software that is to access a key stored in the HSM can be securely authenticated and executed, without the disadvantages of the comparative systems described above (for example, plaintext access credentials may not be stored). Furthermore, security is also improved relative to comparative systems in which a secure enclave is provided but no attestation process is used: in such systems, whilst credentials (such as a PIN or key) for accessing the HSM could be stored in the enclave, there would still be a risk of key extraction from attacks such as variants of the Spectre exploit. If the key were extracted, an attacker could use the HSM as though it were the authorised software. The attestation process is not vulnerable to key extraction in this manner, and thus the presently described example provides improved security.

In an example, the secure enclave circuitry is configured to validate said operation. The secure enclave circuitry may be configured to perform said validating by confirming that said operation satisfies a security policy. For example, the security policy may indicate that the software must have been validated by each of a set of parties (such as a software developer, a team leader, and a member of a legal team). This example can be implemented within the context of code-signing, wherein the validation performed by the secure enclave circuitry comprises validating signatures that are present on a piece of software and evaluating them against the aforementioned security policy. Following this, a signature can be obtained from the HSM and appended to the signature list. In some such examples, the aforementioned operation can be recorded in an audit log, after which all signatures other than the above-mentioned HSM signature can be pruned (since, in this example, the HSM holds authority for software distribution).

In an example, as part of the attestation process the secure enclave circuitry is configured to receive an attestation challenge from the HSM and, responsive to receiving said challenge, transmit an attestation response to the hardware security module. This provides an efficient and effective way to securely authenticate the computer program instructions to the HSM. Either or both of the secure enclave circuitry and the HSM may be configured to verify the attestation with a third party verifier (which may for example be provided by the manufacturer of the secure enclave circuitry, or the manufacturer of the HSM, or a developer or administrator of the computer program instructions).

In different examples, the attestation challenge and response can take different forms. For example, the attestation response may comprise data indicative of said operation, such as a cryptographic hash of at least a subset of said computer program instructions corresponding to said operation. This provides assurance that the instructions are indeed what they are purported to be. Alternatively or additionally, the attestation challenge may comprise random data, which may in turn be included in the attestation response. This allows assurance that the attestation response was freshly generated by the enclave circuitry and not, for example, based on a stored hash of allowable code (the actual code having been replaced with non-allowed code). More generally, the attestation response may comprise data indicative of the attestation challenge.

In an example, the secure enclave circuitry is configured to, as part of the attestation process, transmit to the hardware security module data indicative of at least one of a software identity and a software instance identity corresponding to said operation. These allow the attestation process to provide assurance that the software, and/or the specific instance of that software being executed, is permitted to use the cryptographic key via the HSM.

In an example, the secure enclave circuitry is configured to establish a secure communication channel for communicating with the hardware security module. This allows for secure communication between the secure enclave circuitry and the HSM during the performance of the operation, which protects against eavesdropping and compromising of the operation by a malicious third party. The secure channel may be established as part of the attestation process. In one such example, the channel is terminated once the operation has been executed. This may be achieved by way of an ephemeral public key, associated with the (temporary) secure communication channel and determined by the secure enclave circuitry as part of establishing the secure communication channel. The ephemeral public key is used until the execution of the operation is concluded, after which the secure enclave circuitry terminates the secure communication channel. The short term nature of such a communication allows active access management. For example, a maximum attestation lifetime may be imposed.

As set out above, in one aspect of the present disclosure, an apparatus (which may be considered an HSM apparatus) comprises interface circuitry to communicate with secure enclave circuitry of a processing device, and HSM circuitry configured to store a cryptographic key. The processing device may for example be the above-described processing device comprising processing circuitry and secure enclave circuitry. The HSM circuitry is configured to receive, from the secure enclave circuitry and via the interface circuitry, a request to open a communication channel. The HSM circuitry is configured to then perform, with the secure enclave circuitry, an attestation process in respect of an operation, said operation comprising accessing the cryptographic key. As explained above in the context of the processing device, this attestation process allows the HSM circuitry to receive a secure assurance that the software being executed by the secure enclave circuitry is permitted to perform the operation. Responsive to a successful outcome of the attestation process, the HSM circuitry performs the operation. The HSM circuitry may be configured to transmit, to the secure enclave circuitry via the interface circuitry, an output of the operation. Software executed by the secure enclave circuitry can thus request specific operations to be performed by the HSM circuitry using the key, after which the results of that operation are provided back to the secure enclave circuitry.

In an example, the HSM circuitry is configured to perform the attestation process by transmitting an attestation challenge to the secure enclave circuitry via the interface circuitry, receiving an attestation response from the secure enclave circuitry via the interface circuitry, and verifying the attestation response. Alternatively or additionally, the verification may be performed on behalf of the HSM by the secure enclave circuitry. The attestation process can thus be performed in essentially the same manner that is described above from the perspective of the processing device.

In one such example, the HSM circuitry is configured to receive data indicative of allowed operations in respect of the cryptographic key. The HSM circuitry then uses the data indicative of the allowed operations to verify the attestation response by confirming that said operation is an allowed operation. This provides an effective way for the HSM to verify that the software executed by the secure enclave circuitry is permitted to instruct the HSM to perform operations in relation to the cryptographic key. For example, the policy may be an access control list. For each key, different operations may be allowed based on various factors such as, for example, enclave attested contents, an attestation verifier identity, enclave contents authorisation, enclave identity tokens, and an enclave hardware version. Thus, “enable” or “disable” can be imposed upon each combination of key, operation, and software identity.

Examples of the present disclosure will now be described with reference to the drawings.

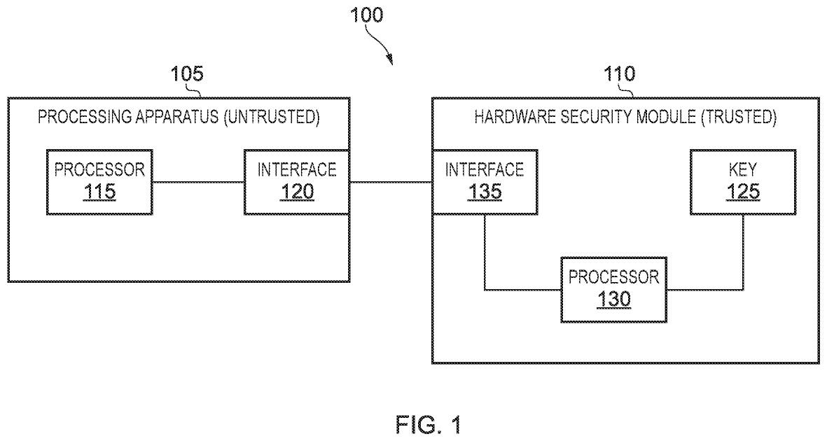

FIG. 1 schematically shows a system 100 according to a comparative example which does not implement some aspects of the present disclosure. The system 100 comprises a processing apparatus 105 communicatively coupled to a HSM 110. The HSM 110 is trusted, but the processing apparatus 105 is not trusted. For example, software executed by the processing apparatus 105 may not be authenticated as free from tampering.

The processing apparatus 105 comprises a processor 115 for executing computer program instructions, and an interface 120 via which the processor 115 can communicate with the HSM 110.

The HSM 110 comprises a key store 125 for storing one or more cryptographic keys. The HSM 110 further comprises a processor 130 for performing cryptographic operations with the key or keys in the key store 125, and an interface 135 via which the processor 130 can communicate with the processing apparatus 105.

The processor 115 of the processing apparatus 105 can instruct the processor 130 of the HSM 110 to perform a cryptographic operation with a key in the key store 125. This allows the cryptographic operation to be performed without the processor 115 of the processing apparatus 105 having access to the key. The functionality of the HSM processor 130 is typically restricted to performing such cryptographic operations, with general programmability being limited. This improves security of the keys stored in the key store 125, but also means that the HSM 110 has little ability to verify the cryptographic operation it is instructed to perform. The burden of verification is thus placed on the processing apparatus 115, which may have been compromised.

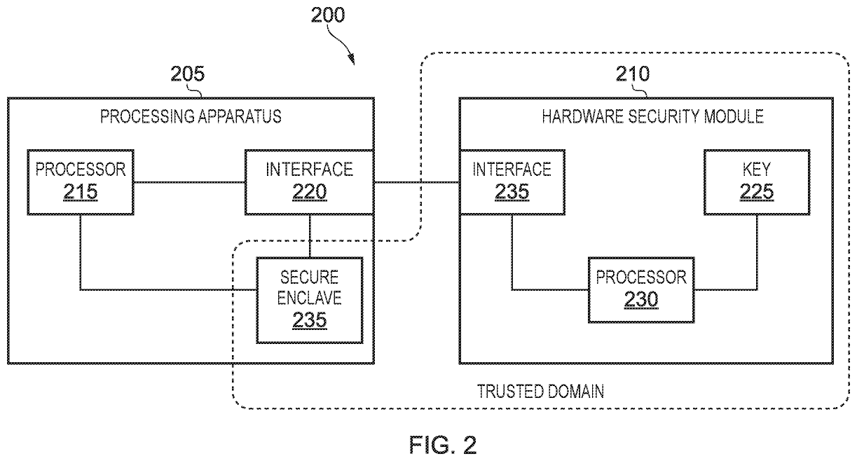

FIG. 2 schematically illustrates a system 200 according to an example of the present disclosure. Similarly to the system 100 of FIG. 1, the system 200 comprises a processing apparatus 205 and a HSM 210.

The processing apparatus 205 comprises a processor 215 for executing computer program instructions, and an interface 220 for communication with the HSM 210.

The HSM 210 comprises a key store 225 for storing one or more cryptographic keys. The HSM 210 further comprises a processor 230 for performing cryptographic operations with the key or keys in the key store 225, and an interface 235 via which the processor 230 can communicate with the processing apparatus 205.

The processing apparatus 205 further comprises a secure enclave 235. The processor 215 can configure the secure enclave to execute computer program instructions corresponding to the aforementioned cryptographic operation. The secure enclave 235 executes computer program code in a secure manner, for example by verifying operations against security policies prior to execution.

Following the aforementioned configuration, the secure enclave 235 is configured to initiate a secure communication channel with the processor 230 of the HSM 210, via the interfaces 220, 235. The secure enclave 235 then performs an attestation process with the HSM processor 230, in order to prove to the HSM processor 230 that the computer program instructions that are to be executed are permitted to access the HSM 210.

Following attestation, the HSM processor 230 can have confidence that the operation that is to be executed is a permitted operation: the identity of the code executed by the secure enclave 235 has been proved. Thus, whereas in the comparative system 100 of FIG. 1 the HSM 110 was trusted and the processing apparatus 105 was untrusted, in the present example a trusted domain can be considered to include the HSM 210 and also the secure enclave 235 of the processing apparatus 205, whilst the processor 215 of the processing apparatus 205 remains untrusted.

Finally, the secure enclave 235 executes the cryptographic operation. This may for example comprise instructing the HSM processor 230 to perform particular operations in relation to a key in the key store 225, after which the HSM processor 230 returns a result to the secure enclave 235.

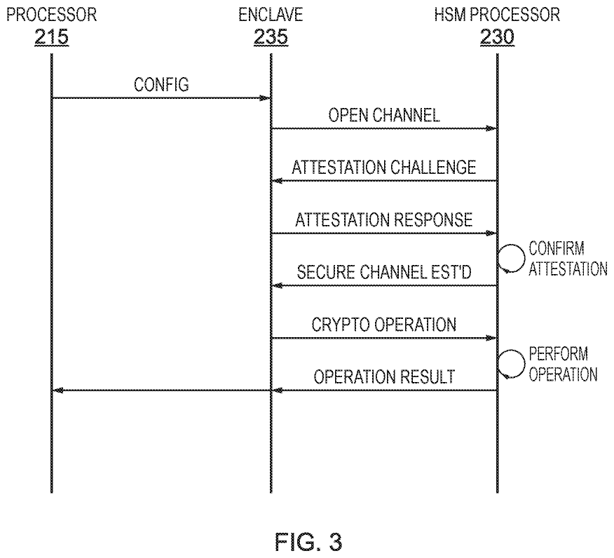

FIG. 3 is a communication process diagram which schematically illustrates an example method by which a cryptographic operation can be performed within the system 200 of FIG. 2. For conciseness and clarity, FIG. 3 shows the processor 215, the enclave 235 and the HSM processor 210, but does not show the interfaces 220, 235 or the key store 225 (whose functionality can be understood from FIG. 2).

Initially, having determined that a cryptographic operation is to be executed which will require a key that is stored in the HSM 210, the processor 215 configures the enclave 235 to perform said operation.

The enclave 235 transmits a channel open message to the HSM processor 230, to open a communication channel. Further messages may be transmitted back and forth as part of opening the channel. For example, a handshake message and handshake response message may be exchanged.

The HSM processor 230 then transmits an attestation challenge to the enclave 235. In response, the enclave 235 transmits an attestation response to the HSM processor 230. Particular examples of the content of these messages are described elsewhere in the present disclosure. Having received the attestation response, the HSM processor 230 confirms the attestation, such that the HSM processor 230 is assured that the cryptographic operation is permitted. The HSM processor 230 then indicates to the enclave 235 that a secure channel has been established, and the enclave 235 is permitted to instruct the HSM processor 230 to perform the cryptographic operation.

The enclave 235 then instructs the HSM processor 230 to perform the cryptographic operation. The HSM processor 230 performs the operation, and transmits the results to the enclave 235. The enclave, in turn, transmits the results to the processor 215. The cryptographic operation can thus be performed, and the processor 215 provided with the results, without compromising security.

Following provision of the result to the processor 215, the secure channel is terminated and the enclave 235 cleared of its configuration (not shown in FIG. 3).

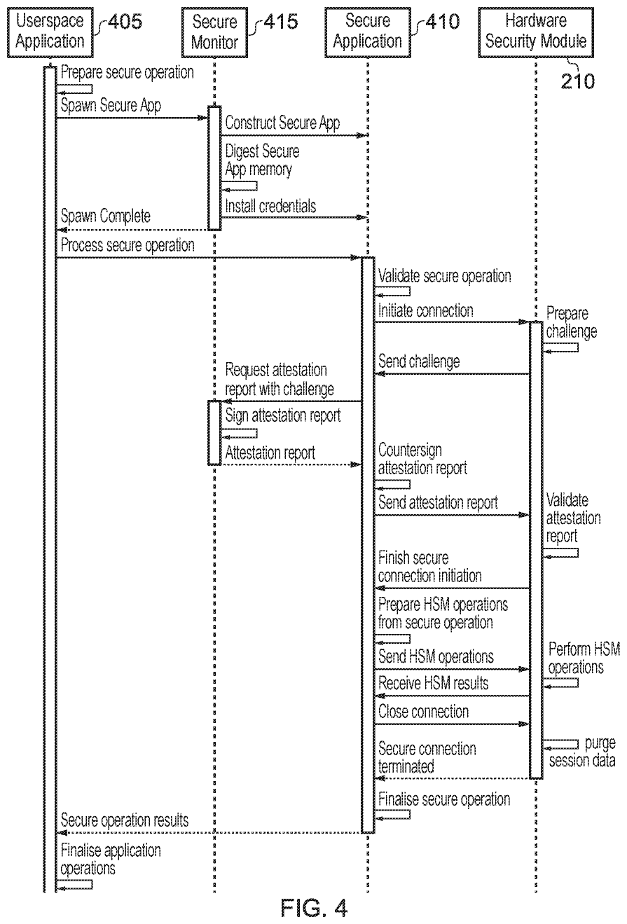

FIG. 4 is a communication process diagram which illustrates a more detailed method by which a userspace application 405, executing within a processor 215, can cause a cryptographic operation to be performed. The diagram further includes a secure application 410 executing within a secure enclave 235, a secure monitor 415 (which is a hardware component that allows the enclave 235 to be set up) and a HSM 210.

Initially, the application 405 prepares a cryptographic operation which requires access to a key that is protected by the HSM 410. The application communicates with the secure monitor 415 to spawn the secure application 410 within the enclave 410. This comprises constructing the secure application 410 and installing appropriate credentials thereon.

Following the spawning of the secure application 410, the application 405 instructs the secure application 410 to process the secure operation. In response to this, the secure application 410 validates the secure operation and initiates a connection to the HSM 210.

The HSM 210 then prepares an attestation challenge and transmits this to the secure application 410. The attestation challenge includes an ephemeral public key (which may function as a cryptographic nonce, or in other examples a separate nonce may be used) and is signed by the HSM 210.

The secure application 410 verifies the attestation challenge and generates an ephemeral key pair. The secure application 410 then uses the secure monitor 415 to generate an attestation report: the secure application 410 transmits the attestation challenge, with a report request, to the secure monitor 415. The secure monitor generates and signs the attestation report and transmits the report to the secure application 410. The report comprises at least one digest of at least one memory region of the enclave (either at the time of load, or at the current time; example regions being data regions and code regions), the enclave ephemeral public key, a digest of the attestation challenge (or the attestation challenge verbatim), and a signature over the attestation report.

The secure application 410 countersigns the attestation report. The counter-signature provides a software identity so that each instance of a particular piece of software can be identified separately. This allows for access control on a more granular basis, including managing expiry of authorisation.

The secure application 410 transmits the report to the HSM 210. The HSM 210 verifies the attestation report, which may for example be performed by way of a third party attestation verification service. The HSM 210 then concludes the key exchange protocol with the secure application 410 (which may for example be performed using a Diffie-Hellman algorithm). From this point, the enclave and HSM 210 share an authenticated, secure channel which can be used to perform the operation prepared by the application.

To perform the operation, the secure application 410 prepares the HSM operations from the secure operation with which it was configured (i.e. the secure application 410 determines which operations should be performed by the HSM). The secure application 410 then communicates these operations to the HSM 210. The HSM 210 performs the HSM operations, and returns the results to the secure application 410.

Once the HSM operation results have been received, the secure application 410 closes the secure connection, following which the HSM 210 purges the session data and confirms to the secure application 410 that the secure connection is terminated. The secure application 410 then finalises the secure operation and transmits the results to the userspace application 405. Finally, the userspace application 405 finalises its application operations, for example using the results of the secure operation as an input to further processing operations.

Alternative implementations are possible within the same principles. For example, the enclave may load and validate the application's requested operation after the secure connection is established with the HSM 210.

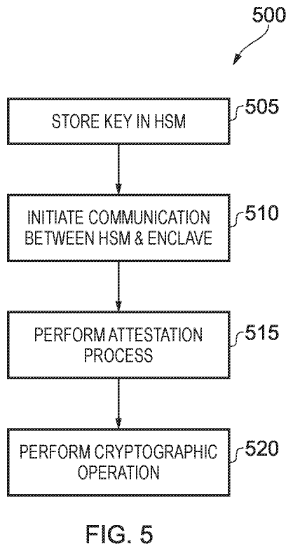

FIG. 5 illustrates a method 500 according to an example of the present disclosure. The method may for example be implemented within the system 200 of FIG. 2.

At block 505, a key is stored in an HSM.

At block 510, communication is initiated between the HSM and a secure enclave of a processing device.

At block 515, the secure enclave and HSM perform an attestation process in respect of an operation to be performed by the secure enclave. This operation comprises accessing a cryptographic key.

At block 520, responsive to a successful outcome of the attestation process, the aforementioned operation is performed by the secure enclave. The HSM facilitates performance of the operation.

Apparatuses and methods are thus provided for software to be securely authenticated to an HSM.

From the above description it will be seen that the techniques described herein provides a number of significant benefits. In particular, the degree of security is improved relative to comparative examples in which aspects of the present disclosure are not implemented.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

We claim:

1. An apparatus comprising:
secure enclave circuitry;
processing circuitry to execute computer program instructions, wherein:
the computer program instructions correspond to an operation comprising:
accessing a cryptographic key stored in a hardware security module; and
wherein executing the computer program instructions comprises transmitting, to the secure enclave circuitry, computer program instructions corresponding to said operation,
the secure enclave circuitry being configured to:
initiate communication with the hardware security module;
perform, with the hardware security module, an attestation process in respect of said operation;
execute said operation.

2. An apparatus according to claim 1, wherein the attestation process is based on said computer program instructions corresponding to said operation.

3. An apparatus according to claim 1, wherein the secure enclave circuitry is configured to validate said operation.

4. An apparatus according to claim 3, wherein the secure enclave circuitry is configured to perform said validating by confirming that said operation satisfies a security policy.

5. An apparatus according to claim 1, wherein the secure enclave circuitry is configured to, as part of the attestation process:
receive an attestation challenge from the hardware security module; and
responsive to receiving said challenge, transmit an attestation response to the hardware security module.

6. An apparatus according to claim 5, wherein the attestation challenge comprises random data generated by the hardware security module.

7. An apparatus according to claim 5, wherein the attestation response comprises data indicative of said operation.

8. An apparatus according to claim 7, wherein the data indicative of said operation comprises a cryptographic hash of at least a subset of said computer program instructions corresponding to said operation.

9. An apparatus according to claim 5, wherein the attestation response comprises data indicative of the attestation challenge.

10. An apparatus according to claim 1, wherein the secure enclave circuitry is configured to, as part of the attestation process, transmit to the hardware security module data indicative of at least one of a software identity and a software instance identity corresponding to said operation.

11. An apparatus according to claim 1, wherein the secure enclave circuitry is configured to establish a secure communication channel for communicating with the hardware security module.

12. An apparatus according to claim 11, wherein the secure enclave circuitry is configured to perform said establishing of the secure communication channel as part of the attestation process.

13. An apparatus according to claim 11, wherein:
as part of establishing the secure communication channel, the secure enclave circuitry is configured to determine an ephemeral public key associated with the secure communication channel; and
the secure enclave circuitry is configured to terminate the secure communication channel responsive to conclusion of execution of said operation.

14. An apparatus according to claim 1, wherein the secure enclave circuitry is configured to block external transmission, to entities other than the hardware security module, of secure data associated with said operation.

15. An apparatus according to claim 1, wherein the secure enclave circuitry is configured to transmit to the processing circuitry an output of said operation.

16. An apparatus comprising:
interface circuitry to communicate with secure enclave circuitry of a processing device; and
hardware security module circuitry to:
receive, from the secure enclave circuitry and via the interface circuitry, a request to open a communication channel;
perform, with the secure enclave circuitry, an attestation process in respect of an operation, said operation comprising accessing a stored cryptographic key; and
responsive to a successful outcome of the attestation process, perform said operation.

17. An apparatus according to claim 16, wherein the hardware security module circuitry is configured to transmit, to the secure enclave circuitry via the interface circuitry, an output of said operation.

18. An apparatus according to claim 16, wherein the hardware security module circuitry is configured to perform the attestation process by:
transmitting an attestation challenge to the secure enclave circuitry via the interface circuitry;
receiving an attestation response from the secure enclave circuitry via the interface circuitry; and
verifying the attestation response.

19. An apparatus according to claim 18, wherein the hardware security module circuitry is configured to:
receive data indicative of allowed operations in respect of the cryptographic key; and
use the data indicative of the allowed operations to verify the attestation response by confirming that said operation is an allowed operation.

20. A method comprising:
initiating communication between a hardware security module and a secure enclave of a processing device;
performing, by the secure enclave and the hardware security module, an attestation process in respect of an operation to be performed by the secure enclave, said operation comprising accessing a cryptographic key stored in the hardware security module; and
responsive to a successful outcome of the attestation process, performing said operation by the secure enclave, wherein the hardware security module facilitates performance of said operation.
